(19) United States
(12) Patent Application Publication
(10) Pub. No.: US 2025/0158679 A1
(43) Pub. Date: May 15, 2025

(54) METHOD AND APPARATUS FOR DETERMINING CSI PROCESSING UNIT, DEVICE, AND STORAGE MEDIUM

(71) Applicant: Beijing Xiaomi Mobile Software Co., Ltd., Beijing (CN)

(72) Inventors: Mingju LI, Beijing (CN); Qin MU, Beijing (CN)

(21) Appl. No.: 18/838,342

(22) PCT Filed: Feb. 18, 2022
(86) PCT No.: PCT/CN2022/076910

§ 371 Date: Aug. 14, 2024

(51) Int. Cl. H04B 7/06; H04W 24/10

(52) U.S. Cl. CPC H04B 7/0626; H04W 24/10

(57) ABSTRACT

A method for determining a channel state information (CSI) processing unit is performed by a user equipment. The method includes: determining a number of CSI processing units occupied by a CSI report of at least one of a first type set or a second type set; wherein the number of CSI processing units occupied by the CSI report in the first type set cannot exceed a first value, and the number of CSI processing units occupied by the CSI report in the second type set cannot exceed a second value.

### CROSS REFERENCE TO RELATED APPLICATION

The present application is a U.S. National Stage of International Application No. PCT/CN2022/076910, filed on Feb. 18, 2022, the content of which is incorporated by reference herein in its entirety.

### TECHNICAL FIELD

The present disclosure relates to the field of communications, and in particular relates to a method and an apparatus for determining a channel state information (CSI) processing unit, a device and a storage medium.

### BACKGROUND

In the communication system, the measurement and reporting mechanism of CSI is involved.

The user equipment processes the measurement result of the CSI reference signal through the CSI processing unit on its side to generate a CSI report, and the number of CSI processing units required for different types of CSI reports varies. The user equipment then sends the generated CSI report to the network device side.

### SUMMARY

The embodiments of the present disclosure provide a method and an apparatus for determining a CSI processing unit, a device and a storage medium. The technical solution is as follows.

According to an aspect of the embodiments of the present disclosure, there is provided a method for determining a channel state information CSI processing unit, performed by a user equipment, including:
determining a number of CSI processing units occupied by CSI reports of a first type set and/or a second type set;
where the number of CSI processing units occupied by CSI reports in the first type set cannot exceed a first value, and the number of CSI processing units occupied by CSI reports in the second type set cannot exceed a second value.

According to an aspect of the embodiments of the present disclosure, there is provided a method for determining a channel state information CSI processing unit, performed by a network device, including:
receiving a CSI report reported by a user equipment;
where the CSI report includes a CSI report of a first type set and/or a second type set on the user equipment side; a number of CSI processing units occupied by the CSI report in the first type set cannot exceed a first value, and a number of CSI processing units occupied by the CSI report in the second type set cannot exceed a second value.

According to another aspect of the embodiments of the present disclosure, there is provided a device for determining a channel state information CSI processing unit, including a processing module;
the processing module is configured to determine a number of CSI processing units occupied by CSI reports of a first type set and/or a second type set;
wherein, the number of CSI processing units occupied by the CSI reports in the first type set cannot exceed a first value, and the number of CSI processing units occupied by the CSI reports in the second type set cannot exceed a second value.

According to another aspect of the embodiments of the present disclosure, there is provided a device for determining a channel state information CSI processing unit, including a receiving module;
the receiving module is configured to receive a CSI report reported by a user equipment;
where the CSI report includes a CSI report of a first type set and/or a second type set on the user equipment side; a number of CSI processing units occupied by the CSI reports in the first type set cannot exceed a first value, and a number of CSI processing units occupied by the CSI reports in the second type set cannot exceed a second value.

According to another aspect of the embodiments of the present disclosure, there is provided a user equipment, including: a processor; a transceiver connected to the processor; where the processor is configured to load and execute executable instructions to implement the method for determining the CSI processing unit according to the above aspects.

According to another aspect of the embodiments of the present disclosure, there is provided network device, including: a processor; a transceiver connected to the processor; where the processor is configured to load and execute executable instructions to implement the method for determining the CSI processing unit according to the above aspects.

According to another aspect of the embodiments of the present disclosure, there is provided a computer-readable storage medium, where at least one instruction, at least one program, code set or instruction set is stored thereon, and the at least one instruction, the at least one program, the code set or instruction set is loaded and executed by the processor to implement the method for determining the CSI processing unit according to the above various aspects.

According to another aspect of the embodiments of the present disclosure, there is provided a chip. The chip includes a programmable logic circuit and/or a program instruction. When the chip is running, it is configured to implement the method for determining the CSI processing unit described in the above various aspects.

According to another aspect of the embodiments of the present disclosure, there is provided a computer program product (or computer program). The computer program product (or the computer program) includes a computer instruction. The computer instruction is stored in a computer-readable storage medium. The processor of the computer device reads the computer instruction from the computer-readable storage medium, and the processor executes the computer instruction, so that the computer device executes the method for determining the CSI processing unit according to the above-mentioned various aspects.

It should be understood that the above general description and the detailed description below are only exemplary and explanatory, and cannot limit the present disclosure.

### BRIEF DESCRIPTION OF THE DRAWINGS

The following will briefly introduce the accompanying drawings of the present disclosure. Obviously, the drawings described below are only example embodiments of the present disclosure.

FIG. 1 is a block diagram of a communication system according to an embodiment;

FIG. 2 is a flow chart of a method for determining a CSI processing unit according to an embodiment;

FIG. 3 is a flow chart of a method for determining a CSI processing unit according to another embodiment;

FIG. 4 is a flow chart of a method for determining a CSI processing unit according to another embodiment;

FIG. 5 is a block diagram of a device for determining a CSI processing unit according to an embodiment;

FIG. 6 is a block diagram of a device for determining a CSI processing unit according to another embodiment;

FIG. 7 is a schematic diagram of a structure of a user equipment according to an embodiment;

FIG. 8 is a schematic diagram of a structure of a network device according to an embodiment.

### DETAILED DESCRIPTION

Here, embodiments will be described in detail, and examples thereof are shown in the accompanying drawings. When the following description refers to the drawings, unless otherwise indicated, the same numbers in different drawings represent the same or similar elements. The embodiments described in the following embodiments do not represent all embodiments consistent with the present disclosure. Instead, they are only examples of devices and methods consistent with some aspects of the present disclosure as detailed in the attached claims.

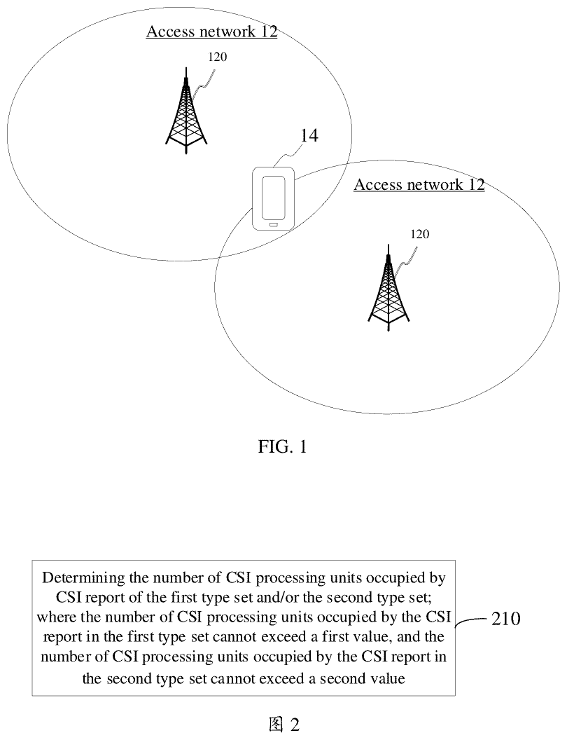

FIG. 1 shows a block diagram of a communication system provided by an embodiment of the present disclosure, and the communication system may include an access network 12 and a user equipment 14.

The access network 12 includes several access network devices 120. The access network device 120 may be a base station. The base station is a device deployed in the access network to provide wireless communication functions for the user equipment (referred to as “terminal”) 14. The base station may include various forms of macro base stations, micro base stations, relay stations, access points, etc. In systems using different wireless access technologies, the names of devices with base station functions may be different. For example, in the Long Term Evolution (LTE) system, it is called eNodeB or eNB; in the 5G New Radio (NR) system, it is called gNodeB or gNB. As communication technology evolves, the description of “base station” may change. For the convenience of description in the embodiments of the present disclosure, the above-mentioned devices that provide wireless communication functions for the user equipment 14 are collectively referred to as network devices.

The user equipment 14 may include various device with wireless communication function such as a handheld device, a vehicle-mounted device, a wearable device, a computing device or other processing device connected to a wireless modem, as well as various forms of user equipment, a mobile station (MS), a terminal device, etc. For the convenience of description, the above-mentioned devices are collectively referred to as user equipment. The access network device 120 and the user equipment 14 communicate with each other through some air interface technology, such as the Uu interface.

The technical solutions of the embodiments of the present disclosure can be applied to various communication systems, such as Global System of Mobile Communication (GSM) system, Code Division Multiple Access (CDMA) system, Wideband Code Division Multiple Access (WCDMA) system, General Packet Radio Service (GPRS), Long Term Evolution (LTE) system, LTE Frequency Division Duplex (FDD) system, LTE Time Division Duplex (TDD) system, Advanced Long Term Evolution (LTE-A) system, New Radio (NR) system, evolution system of NR system, LTE-based access to Unlicensed spectrum (LTE-U) system, NR-U system, Universal Mobile Telecommunication System (UMTS), Worldwide Interoperability for Microwave Access (WiMAX) communication system, Wireless Local Area Network (WLAN) system, Wireless Fidelity (WiFi), next generation communication systems or other communication systems.

Generally speaking, the number of connections supported by traditional communication systems is limited and easy to implement. However, with the development of communication technology, mobile communication systems will not only support traditional communications, but also support, for example, device to device (D2D) communication, machine to machine (M2M) communication, machine type communication (MTC), vehicle to vehicle (V2V) communication and vehicle to everything (V2X) system. The embodiments of the present disclosure can also be applied to these communication systems.

In the related art, a CSI measurement and reporting mechanism is involved.

For example, the network device can configure or indicate a CSI reference signal resource to the user equipment, and configure a CSI report content for the CSI reference signal resource. After the user equipment obtains the CSI reference signal resource, the user equipment can allocate a CSI processing unit for the CSI reference signal resource and the CSI report content, thereby performing a measurement process on the CSI reference signal. After the CSI processing unit measures the CSI reference signal, it can process (such as calculate, analyze, etc.) the measurement result and generate a CSI report based on the processing result.

In the related art, the user equipment needs to report the number N of CSI processing units that can be supported and processed simultaneously, that is, the user equipment has N CSI processing units. If L CSI processing units are already occupied on the current symbol, then only N-L CSI processing units are left.

If there are currently multiple CSI reports that need to be processed, that is, multiple CSI reports compete for these N-L CSI processing units, then it is necessary to first determine whether these N-L CSI processing units are enough for these multiple CSI reports. In addition, for different CSI reports, the number of CSI processing units occupied is different. In the case where N-L CSI processing units are not enough for these multiple CSI reports, multiple CSI reports need to compete for N-L CSI processing units based on their respective CSI report priorities.

Traditional CSI reports do not combine AI technology. When there is an AI-based CSI report, how to determine the number of CSI processing units occupied by the AI-based CSI report and how to determine the priority of the AI-based CSI report, the related art has not yet provided a solution.

FIG. 2 shows a method flow chart of a method for determining a CSI processing unit provided by an embodiment of the present disclosure. The method is applied to a user equipment of the communication system shown in FIG. 1, and the method includes the following steps.

Step 210: Determining the number of CSI processing units occupied by CSI report of the first type set and/or the second type set; where the number of CSI processing units occupied by the CSI report in the first type set cannot exceed a first value, and the number of CSI processing units occupied by the CSI report in the second type set cannot exceed a second value.

It can be understood that the CSI report (report) in the embodiment of the present disclosure can also be understood as CSI.

The CSI processing unit (CPU) is a processing unit on the user equipment side for generating a CSI report. Each CSI report needs to occupy a certain number of CSI processing units for processing.

In the embodiments of the present disclosure, there are two different embodiments as follows:
Embodiment 1: There is only one type set, and the number of CSI processing units occupied by the CSI report in the type set cannot exceed a numerical threshold.

In the embodiments of the present disclosure, only one existing type set is taken as the first type set for illustration.

For example, the user equipment determines the number of CSI processing units occupied by the CSI report of the first type set. The number of CSI processing units occupied by the CSI report in the first type set cannot exceed a first value. For example, the first value is the number of the CSI processing units possessed by the user equipment.

For example, the CSI report of the first type set includes a traditional CSI report and a non-traditional CSI report. The non-traditional CSI report can also be understood as a CSI report generated by an AI-based processing method.
Embodiment 2: There are both the first type set and the second type set, the number of CSI processing units occupied by the CSI report in the first type set cannot exceed a first value, and the number of CSI processing units occupied by the CSI report in the second type set cannot exceed a second value.

For example, the user equipment determines the number of CSI processing units occupied by the CSI reports of the first type set and the second type set respectively. The number of CSI processing units occupied by the CSI reports in the first type set cannot exceed the first value, and the number of CSI processing units occupied by the CSI reports in the second type set cannot exceed the second value. For example, the first value is the number of CSI processing units of the first type possessed by the user equipment, and the second value is the number of CSI processing units of the second type possessed by the user equipment.

For example, the first type of CSI processing unit is a CSI processing unit for generating a traditional CSI report, and the second type of CSI processing unit is a CSI processing unit for generating a non-traditional CSI report or an AI-based CSI report. In addition, the first type of CSI processing unit can also be understood as a traditional CSI processing unit or a non-AI-based CSI processing unit, etc., and the second type of CSI processing unit can also be understood as a processing unit different from a traditional CSI processing unit, an AI-based CSI processing unit, or a CSI processing unit that uses an AI model for information processing, etc.

It should be understood that the second type of CSI processing unit may also be a CSI processing unit other than AI, which is different from the traditional CSI processing unit, and the embodiments of the present disclosure do not limit this. In the following embodiments, only an example where the second type of CSI processing unit is an AI-based CSI processing unit, and the non-traditional CSI report is an AI-based CSI report is illustrated.

In some examples, at least one of the first type set and the second type set contains an AI-based CSI report.

For example, in the above-mentioned embodiment 1, since there is only one type set, the CSI report in the type set may include a traditional CSI report and an AI-based CSI report. In the above-mentioned embodiment 2, since there are two type sets, one type set may include a traditional CSI report, and the other type set may include an AI-based CSI report.

In summary, in the method for determining the CSI processing unit provided by the embodiment, the user equipment determines the number of CSI processing units occupied by the CSI report of a type set, and the number of CSI processing units occupied by the CSI report in the type set cannot exceed the first value; or, the user equipment determines the number of CSI processing units occupied by the CSI reports of two type sets respectively, and the number of CSI processing units occupied by the CSI report of each type set cannot exceed the numerical threshold corresponding to the type set. When there is a CSI report (such as an AI-based CSI report) different from the traditional CSI report, a method for determining the two different CSI processing units as described above is provided.

For embodiment 1: there is only the first type set, and the number of CSI processing units occupied by the CSI report in the type set cannot exceed the first value.

In the embodiment, the meanings of the CSI processing units corresponding to the traditional CSI report and the AI-based CSI report are the same. The number of CSI processing units occupied by the traditional CSI report and the AI-based CSI report cannot exceed the number of CSI processing units supported by the user equipment (i.e., the first value).

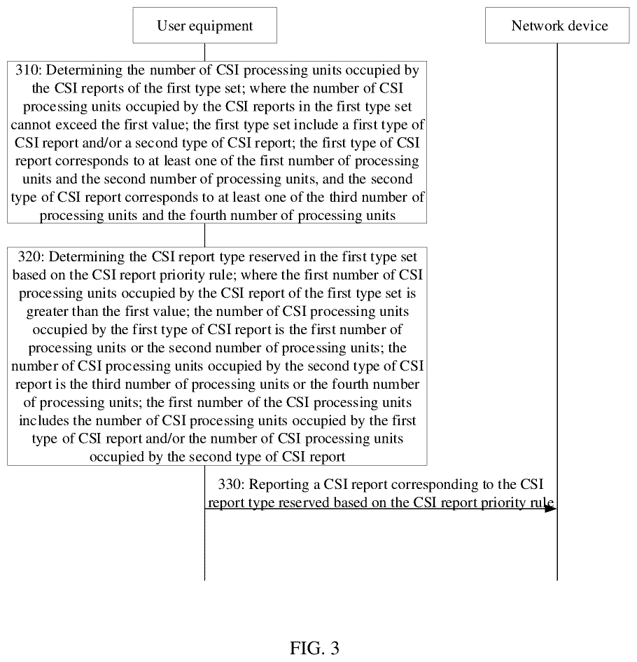

FIG. 3 shows a method flow chart of a method for determining a CSI processing unit provided by an embodiment of the present disclosure. The method is applied to the communication system shown in FIG. 1, and the method include the following steps.

Step 310: the user equipment determines the number of CSI processing units occupied by the CSI reports of the first type set; where the number of CSI processing units occupied by the CSI reports in the first type set cannot exceed the first value. The first type set include a first type of CSI report and/or a second type of CSI report. The first type of CSI report corresponds to at least one of the first number of processing units and the second number of processing units, and the second type of CSI report corresponds to at least one of the third number of processing units and the fourth number of processing units.

That is, in the case where there is only one type set (the first type set), the type set include a first type of CSI report and/or a second type of CSI report. The number of CSI processing units occupied by the first type of CSI report is at least one of the two numbers of processing units. The number of CSI processing units occupied by the second type of CSI report is at least one of the two numbers of processing units. The sum of the number of CSI processing units occupied by the first type of CSI report and the second type of CSI report cannot exceed the first value.

In some examples, different numbers of processing units are the numbers of CSI processing units that the same type of CSI report needs to occupy respectively under different processing modes.

For example, the first number of processing units is the number of CSI processing units occupied by the first type of CSI report when the first type of CSI report is not an AI-based CSI report, that is, the first type of CSI report is a traditional CSI report; the second number of processing units is the number of CSI processing units occupied by the first type of CSI report when the first type of CSI report is an AI-based CSI report.

For example, the third number of processing units is the number of CSI processing units occupied by second type of CSI report when the second type of CSI report is not an AI-based CSI report, that is, the second type of CSI report is a traditional CSI report; the fourth number of processing units is the number of CSI processing units occupied by the second type of CSI report when the second type of CSI report is an AI-based CSI report.

As described in the above example, no matter the first type of CSI report/second type of CSI report is a traditional CSI report or an AI-based CSI report, the number of CSI processing units occupied in one type set are counted together, and it is necessary to ensure that the sum of the number of CSI processing units occupied by the two types of CSI reports cannot exceed the first value. Since there is only one type set, the first value can be understood as the number of CSI processing units supported by the user equipment. Therefore, in the embodiment, the meanings of the CSI processing units corresponding to the traditional CSI report and the AI-based CSI report are the same, and the number of CSI processing units occupied by the traditional CSI report and the AI-based CSI report cannot exceed the number of CSI processing units supported by the user equipment, and there is no need to introduce a new CSI processing unit separately for the AI-based CSI report.

In some examples, the first type of CSI report and the second type of CSI report are two different types of CSI reports, and the different types refer to different measurement purposes of the CSI reports or different reporting amounts of the CSI reports.

For example, the first type of CSI report is a CSI report for beam measurement; and the second type of CSI report is a CSI report for CSI feedback.

For example, the reporting amount corresponding to the first type of CSI report includes at least one of the following: CSI reference signal resource indicator-reference signal received power (cri-RSRP); synchronization signal block-index-reference signal received power (ssb-Index-RSRP); CSI reference signal resource indicator-signal to noise ratio (cri-SINR); and synchronization signal block-index-signal to noise ratio (ssb-Index-SINR).

For example, the reporting amount corresponding to the second type of CSI report includes at least one of the following: CSI reference signal resource indicator-rank indication-precoding matrix indication-channel quality indication (cri-RI-PMI-CQI); CSI reference signal resource indicator-rank indication-i1 (cri-RI-i1); CSI reference signal resource indicator-rank indication-i1-channel quality indication (cri-RI-i1-CQI); CSI reference signal resource indicator-rank indication-channel quality indication (cri-RI-CQI); CSI reference signal resource indicator-rank indication-L1—precoding matrix indication-channel quality indication (cri-RI-LI-PMI-CQI).

For example, the second type of CSI report further includes sub-band CSI, or the number of reference signal ports corresponding to the second type report is greater than 4, or the codebook type corresponding to the second type report is one of the following: type I-multipanel; type II; type II-port selection; type II-r16; type II-portselection-r16; type II-portselection-r17.

In the following, the number of CSI processing units occupied by the first type of CSI report and the second type of CSI report shown in the above example is further described.

### (1) Number of CSI Processing Units Occupied by the First Type of CSI Report

The first number of processing units of the first type of CSI report is 1.

The second number of processing units of the first type of CSI report is determined by at least one of the following parameters corresponding to the first type of CSI report:
Input parameter value of the AI model;
   the input parameter value refers to the number of input parameters. For example, the number of second processing units is proportional to the input parameter value of the AI model.
Output parameter value of the AI model;
   the output parameter value refers to the number of output parameters. For example, the number of second processing units is proportional to the output parameter value of the AI model.
Network type of the AI model;

For example, different network types correspond to their own parameter values. The parameter value is used to calculate the number of second processing units. The correspondence between network type and parameter value is predefined by the communication protocol, or configured or indicated to the user equipment by the network device, or customized by the user equipment.
The number of layers of the AI model;

For example, the number of second processing units is proportional to the number of layers of the AI model.
The number of elements in each layer of the AI model;

For example, the number of second processing units is proportional to the number of elements in each layer of the AI model.
The size of the convolution kernel of the AI model;

For example, the number of second processing units is proportional to the size of the convolution kernel of the AI model.

For example, for beam measurement, the number of CSI processing units occupied in traditional cases is 1, that is, the number of first processing units is 1. The number of CSI processing units occupied by AI-based beam measurement is a1, and a1 can contain at least one value. Different values are related to the following parameters: input parameter value and output parameter value of the AI model, network structure of the AI model (network structure includes network type, number of layers, number of elements in each layer, size of convolution kernel, etc.). That is, the number of second processing units is determined by at least one parameter as above.

### (2) Number of CSI Processing Units Occupied by the Second Type of CSI Report

The third number of processing units of the second type of CSI report is the number of channel state information-reference signals (CSI-RS) for channel measurement.

The fourth number of processing units of the second type of CSI report is determined by at least one of the following parameters corresponding to the second type of CSI report:
Input parameter value of the AI model;
Output parameter value of the AI model;
Network type of the AI model;
Number of layers of the AI model;
Number of elements in each layer of the AI model;
Size of the convolution kernel of the AI model.

The influence of each parameter on the fourth number of processing units can be found above and will not be repeated here.

For example, for CSI feedback, the number of CSI processing units occupied in the traditional case is the number of CSI-RS for channel measurement. That is, the third number of processing units is the number of CSI-RS for channel measurement. The number of CSI processing units occupied by AI-based CSI feedback is b1, and b1 may include at least one value. Different values are related to the following parameters: input parameter value and output parameter value of AI model, network structure of AI model (network structure includes network type, number of layers, number of elements per layer, size of convolution kernel, etc.). That is, the number of fourth processing units is determined by at least one parameter as above.

It should be understood that the first type set further includes at least one third type of CSI report in addition to the above-mentioned first type of CSI report and second type of CSI report.

For example, the reporting amount corresponding to the third type of CSI report is none, and the CSI-RS resource set is configured as a tracking reference signal (TRS).

The fifth number of processing units corresponding to the third type of CSI report is 0.

The sixth number of processing units corresponding to the third type of CSI report is determined by at least one of the following parameters corresponding to the third type of CSI report:
Input parameter value of AI model;
Output parameter value of AI model;
Network type of AI model;
Number of layers of AI model;
Number of elements per layer of AI model;
Size of convolution kernel of AI model.

The influence of each parameter on the sixth number of the processing units can be seen above, and will not be repeated here.

For example, for TRS measurement, the number of CSI processing units occupied in the traditional case is 0, that is, the fifth number of the processing units is 0. The number of CSI processing units occupied by AI-based TRS measurement is c1, and c1 can contain at least one value. Different values are related to the following parameters: input parameter value and output parameter value of the AI model, network structure of the AI model (network structure includes network type, number of layers, number of elements in each layer, size of convolution kernel, etc.). That is, the sixth number of the processing units is determined by at least one parameter as above.

For example, the third type of CSI report is aperiodic, and the third type of CSI report corresponds to broadband CSI, and the number of reference signal ports corresponding to the third type of CSI report is not greater than 4, and the third type of CSI report has no CSI reference signal resource indicator (CSI-RS Resource Indicator, CRI) report, and the codebook type corresponding to the third type of CSI report is type I-single panel (typeI-singlepanel) or the reporting amount is CSI reference signal resource indicator-rank indication-channel quality indication (cri-RI-CQI). The third type of CSI report at this time can be called fast CSI report.

The fifth number of processing units corresponding to the third type of CSI report is the first value. The first value here can be understood as the number of CSI processing units supported by the user equipment.

The sixth number of the processing units corresponding to the third type of CSI report is determined by at least one of the following parameters corresponding to the third type of CSI report:
Input parameter value of the AI model;
Output parameter value of the AI model;
Network type of the AI model;
Number of layers of the AI model;
Number of elements in each layer of the AI model;
Size of the convolution kernel of the AI model.

The influence of each parameter on the sixth number of the processing units can

be found above and will not be repeated here.

For example, for fast CSI report, it is traditionally required to occupy all CSI processing units of the user equipment, that is, the fifth number of the processing units is the number of CSI processing units supported by the user equipment. The number of CSI processing units occupied by the AI-based fast CSI report is d1, and d1 can contain at least one value. Different values are related to the following parameters: input parameter value and output parameter value of the AI model, network structure of the AI model (network structure includes network type, number of layers, number of elements in each layer, size of convolution kernel, etc.). That is, the sixth number of the processing units is determined by at least one parameter as above.

Step 320: The user equipment determines the CSI report type reserved in the first type set based on the CSI report priority rule; where the first number of CSI processing units occupied by the CSI report of the first type set is greater than the first value. The number of CSI processing units occupied by the first type of CSI report is the first number of processing units or the second number of processing units. The number of CSI processing units occupied by the second type of CSI report is the third number of processing units or the fourth number of processing units. The first number of the CSI processing units includes the number of CSI processing units occupied by the first type of CSI report and/or the number of CSI processing units occupied by the second type of CSI report.

That is, in the case where there is only one type set (first type set), the type set includes a first type of CSI report and/or a second type of CSI report. If the number of CSI processing units occupied by all CSI reports in the type set (first number of the CSI processing units) exceeds the number of CSI processing units corresponding to the type set (first value), it is necessary to discard some CSI reports with low priority according to the CSI report priority, and retain the remaining CSI reports with high priority, so that the number of CSI processing units occupied by the retained CSI reports does not exceed the number of CSI processing units corresponding to the type set, so as to complete the allocation of CSI processing units.

It should be understood that the first number of CSI processing units also includes the number of CSI processing units occupied by at least one third type of CSI report in the case where the first type set also includes at least one third type of CSI report.

In some examples, the CSI report priority is determined by at least one of the following influence parameters: y, k, c, s; or, the CSI report priority is determined by at least one of the following influence parameters: y, k, c, s, a; where y is a value related to the time domain characteristics and reporting resource type of the CSI report, k is a value related to the content carried by the CSI report, c is the serving cell index, s is the report configuration identifier of the CSI report, and a is a value related to whether the CSI report is based on AI.

That is, the CSI report priority can continue to use the traditional method, which is related to the following influence parameters: y, k, c, s, and has nothing to do with whether the CSI report is based on AI; the parameter a configured to indicate whether the CSI report is based on AI can also be configured as the influence parameter of the CSI report priority.

For example, the CSI report priority is determined by at least one of the following influence parameters: y, k, c, s. The CSI report priority is determined based on the following formula:

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s ∘$$

Where y is a value related to the time domain characteristics and reporting resource type of the CSI report, k is a value related to the content carried by the CSI report, c is the service cell index, s is the report configuration identifier of the CSI report, N_{cells} is the maximum number of service cells configured by the high-level parameters, and Mₛ is the maximum number of CSI report configurations configured by the high-level.

For example, the CSI report priority is determined by at least one of the following influence parameters: y, k, c, s, a. The CSI report priority is determined based on any of the following formulas:

$${Pri}_{iCSI} ( y , k , c , s , a ) = 2 \cdot {N}_{cells} \cdot {M}_{s} \cdot y + {N}_{cells} \cdot {M}_{s} \cdot k + {M}_{s} \cdot c + s + a ;$$

$${Pri}_{iCSI} ( y , k , c , s , a ) = 2 \cdot a \cdot {N}_{cells} \cdot {M}_{s} \cdot y + {N}_{cells} \cdot {M}_{s} \cdot k + {M}_{s} \cdot c + s ;$$

$${Pri}_{iCSI} ( y , k , c , s , a ) = 2 \cdot {N}_{cells} \cdot {M}_{s} \cdot y + a \cdot {N}_{cells} \cdot {M}_{s} \cdot k + {M}_{s} \cdot c + s ;$$

$${Pri}_{iCSI} ( y , k , c , s , a ) = 2 \cdot {N}_{cells} \cdot {M}_{s} \cdot y + {N}_{cells} \cdot {M}_{s} \cdot k + a \cdot {M}_{s} \cdot c + s ;$$

$${Pri}_{iCSI} ( y , k , c , s , a ) = 2 \cdot {N}_{cells} \cdot {M}_{s} \cdot y + {N}_{cells} \cdot {M}_{s} \cdot k + {M}_{s} \cdot c + a \cdot s ;$$

$${Pri}_{iCSI} ( y , k , c , s , a ) = a \cdot 2 \cdot {N}_{cells} \cdot {M}_{s} \cdot y + {N}_{cells} \cdot {M}_{s} \cdot k + {M}_{s} \cdot c + s ;$$

$${Pri}_{iCSI} ( y , k , c , s , a ) = 2 \cdot {N}_{cells} \cdot {M}_{s} \cdot y + a \cdot {N}_{cells} \cdot {M}_{s} \cdot k + {M}_{s} \cdot c + s ;$$

$${Pri}_{iCSI} ( y , k , c , s , a ) = 2 \cdot {N}_{cells} \cdot {M}_{s} \cdot y + {N}_{cells} \cdot {M}_{s} \cdot k + a \cdot {M}_{s} \cdot c + s ;$$

$${Pri}_{iCSI} ( y , k , c , s , a ) = a \cdot 2 \cdot {N}_{cells} \cdot {M}_{s} \cdot y + {M}_{s} \cdot c + {N}_{cells} \cdot {M}_{s} \cdot k + s ;$$

$${Pri}_{iCSI} ( y , k , c , s , a ) = a \cdot 2 \cdot {N}_{cells} \cdot {M}_{s} \cdot y + s + {M}_{s} \cdot c + {N}_{cells} \cdot {M}_{s} \cdot k ;$$

$${Pri}_{iCSI} ( y , k , c , s , a ) = 2 \cdot {N}_{cells} \cdot {M}_{s} \cdot y + a \cdot {N}_{cells} \cdot {M}_{s} \cdot k + s + {M}_{s} \cdot c ;$$

$${Pri}_{iCSI} ( y , k , c , s , a ) = a \cdot 2 \cdot {N}_{cells} \cdot {M}_{s} \cdot y + {N}_{cells} \cdot {M}_{s} \cdot k + {M}_{s} \cdot c + s ;$$

$${Pri}_{iCSI} ( y , k , c , s , a ) = a \cdot 2 \cdot {N}_{cells} \cdot {M}_{s} \cdot y + {N}_{cells} \cdot {M}_{s} \cdot k + s + {M}_{s} \cdot c ;$$

$${Pri}_{iCSI} ( y , k , c , s , a ) = a \cdot 2 \cdot {N}_{cells} \cdot {M}_{s} \cdot y + {M}_{s} \cdot c + s {N}_{cells} \cdot {M}_{s} \cdot k ;$$

$${Pri}_{iCSI} ( y , k , c , s , a ) = a \cdot {N}_{cells} \cdot {M}_{s} \cdot k + {M}_{s} \cdot c + s + 2 \cdot {N}_{cells} \cdot {M}_{s} \cdot y ;$$

$${Pri}_{iCSI} ( y , k , c , s , a ) = a \cdot 2 \cdot {N}_{cells} \cdot {M}_{s} \cdot y + {N}_{cells} \cdot {M}_{s} \cdot k + {M}_{s} \cdot c + s ;$$

Where, y is a value related to the time domain characteristics and reporting resource type of the CSI report, k is a value related to the content carried by the CSI report, c is the service cell index, s is the report configuration identifier of the CSI report, a is a value related to whether the CSI report is based on AI, N_{cells} is the maximum number of service cells configured by the high-level parameters, and Mₛ is the maximum number of CSI report configurations configured by the high-level.

For example, the smaller the value calculated according to the above formulas,

the higher the priority of the CSI report.

For example, in the above formulas, the value of y is shown in the following Table 1.

TABLE 1

| | |
|---|---|
| y = 0 | aperiodic CSI reports to be carried on PUSCH |
| y = 1 | semi-persistent CSI reports to be carried on |
| | PUSCH |
| y = 2 | semi-persistent CSI reports to be carried on |
| | PUCCH |
| y = 3 | periodic CSI reports to be carried on PUCCH |

For example, in the above formulas, the value of k is shown in Table 2 below. L1-RSRP includes at least one of cri-RSRP and ssb-Index-RSRP. L1-SINR includes at least one of cri-SINR and ssb-Index-SINR.

TABLE 2

| | |
|---|---|
| k = 0 | CSI reports carrying L1-RSRP or L1-SINR |
| k = 1 | CSI reports not carrying L1-RSRP or L1-SINR |

For example, in the above formulas, when the CSI report is based on AI, a is 0, and when the CSI report is not based on AI, a is a non-zero value; or, when the CSI report is based on AI, a is a non-zero value, and when the CSI report is not based on AI, a is 0; or, when the CSI report is based on AI, a is a smaller value, and when the CSI report is not based on AI, a is a larger value; or, when the CSI report is based on AI, a is a larger value, and when the CSI report is not based on AI, a is a smaller value.

That is, the priority of the AI-based CSI report is high, and the priority of the traditional CSI report is low; or, the priority of the AI-based CSI report is low, and the priority of the traditional CSI report is high.

Step 330: The user equipment reports to the network device a CSI report corresponding to the CSI report type reserved based on the CSI report priority rule.

Accordingly, the network device receives the CSI report reported by the user equipment. The reported CSI report is a CSI report corresponding to the CSI report type reserved by the user equipment in the first type set based on the CSI report priority rule.

In summary, in the method for determining the CSI processing unit provided in the embodiment, the user equipment determines the number of CSI processing units occupied by the CSI report of a type set, and the number of CSI processing units occupied by the CSI report in the type set cannot exceed the first value. The number of CSI processing units occupied by the traditional CSI report and the AI-based CSI report in a type set is calculated together, and there is no need to introduce a new CSI processing unit separately for the AI-based CSI report.

In addition, the method for determining the CSI processing unit provided in the embodiment defines a method for determining the number of CSI processing units occupied by the AI-based CSI report, and defines a method for determining the priority of the CSI report when the traditional CSI report and the AI-based CSI report compete for the CSI processing unit.

For embodiment 2: there are both the first type set and the second type set, the number of CSI processing units occupied by the CSI report in the first type set cannot exceed the first value, and the number of CSI processing units occupied by the CSI report in the second type set cannot exceed the second value.

In this embodiment, the meanings of the CSI processing units corresponding to the traditional CSI report and the AI-based CSI report are different. The number of CSI processing units occupied by the traditional CSI report cannot exceed the number of the first type of CSI processing units possessed by the user equipment (i.e., the first value), and the number of CSI processing units occupied by the AI-based CSI report cannot exceed the number of the second type of CSI processing units possessed by the user equipment (i.e., the second value).

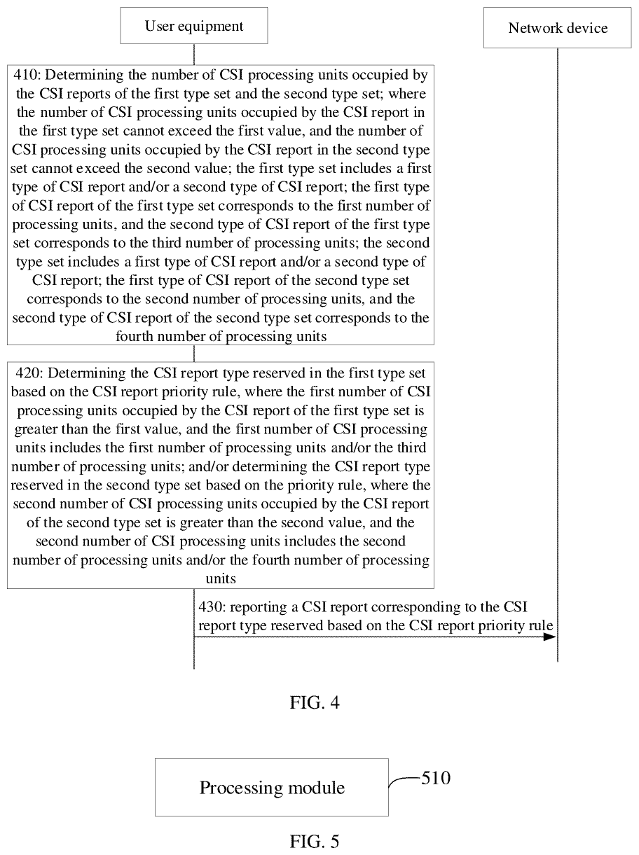

FIG. 4 shows a method flow chart of a method for determining a CSI processing unit provided by an embodiment of the present disclosure. The method is applied to the communication system shown in FIG. 1, and the method includes the following steps.

Step 410: The user equipment determines the number of CSI processing units occupied by the CSI reports of the first type set and the second type set; where the number of CSI processing units occupied by the CSI report in the first type set cannot exceed the first value, and the number of CSI processing units occupied by the CSI report in the second type set cannot exceed the second value. The first type set includes a first type of CSI report and/or a second type of CSI report. The first type of CSI report of the first type set corresponds to the first number of processing units, and the second type of CSI report of the first type set corresponds to the third number of processing units. The second type set includes a first type of CSI report and/or a second type of CSI report. The first type of CSI report of the second type set corresponds to the second number of processing units, and the second type of CSI report of the second type set corresponds to the fourth number of processing units.

That is, in the case where there are two type sets, each type set may include a first type of CSI report and/or a second type of CSI report. The same type of CSI corresponds to one number of processing units in one type set and corresponds to another number of processing units in another type set, and the number of CSI processing units occupied by all CSI reports in the two type sets corresponds to their respective numerical thresholds.

In some examples, different numbers of processing units are the number of CSI processing units that the same type of CSI report needs to occupy under different processing methods.

For example, the first number of processing units is the number of CSI processing units occupied by the first type of CSI report when the first type of CSI report is not an AI-based CSI report, that is, the first type of CSI report is a traditional CSI report; the second number of processing units is the number of CSI processing units occupied by the first type of the CSI report when the first type of CSI report is an AI-based CSI report.

For example, the third number of processing units is the number of CSI processing units occupied by the second type of CSI report when the second type of CSI report is not an AI-based CSI report, that is, the second type of CSI report is a traditional CSI report; the fourth number of processing units is the number of CSI processing units occupied by the second type of CSI report when the second type of CSI report is an AI-based CSI report.

As introduced in the above example, the number of CSI processing units occupied by the first type of CSI report/the second type of CSI report is calculated together in one type set only when both of the first type of CSI report and the second type of CSI report are traditional CSI reports or AI-based CSI reports, and it is necessary to ensure that the number of CSI processing units occupied by all CSI reports in each type set does not exceed the numerical threshold of the type set. Since there are two type sets, the first type set can be understood as the type set corresponding to the traditional CSI report, and the second type set can be understood as the type set corresponding to the AI-based CSI report. Therefore, in this embodiment, the meanings of the CSI processing units corresponding to the traditional CSI report and the AI-based CSI report are different. The number of CSI processing units occupied by the traditional CSI report (i.e., the first type set) cannot exceed the number (i.e., the first value) of the first type of CSI processing units possessed by the user equipment, and the number of CSI processing units occupied by the AI-based CSI report (i.e., the second type set) cannot exceed the number (i.e., the second value) of the second type of CSI processing units possessed by the user equipment. It is necessary to introduce a new CSI processing unit separately for the AI-based CSI report.

It should be understood that the first type set also includes at least one third type of CSI report, and the second type set also includes at least one third type of CSI report in addition to the above-mentioned first type of CSI report and second type of CSI report.

The meanings of the first type of CSI report, the second type of CSI report, and at least one third type report, as well as the number of CSI processing units occupied by each of them, can be referred to the description in step 310, which will not be repeated here.

In some examples, before step 410, the user equipment also performs the following steps:
reporting the capability information of the processing unit, and the capability information of the processing unit carries at least one of the following pieces of information: whether the user equipment supports the AI-based CSI processing unit; the number of the AI-based CSI processing units that can be supported.

Accordingly, the network device receives the capability information of the processing unit reported by the user equipment. Through this information, the network device can clarify the capability information of the processing unit of the user equipment, thereby unifying the calculation of the CSI processing unit between the network device and the user equipment.

For example, before the network device configures the CSI report to the user equipment, the user equipment reports the capability information of the processing unit.

Step 420: The user equipment determines the CSI report type reserved in the first type set based on the CSI report priority rule, where the first number of CSI processing units occupied by the CSI report of the first type set is greater than the first value, and the first number of CSI processing units includes the first number of processing units and/or the third number of processing units; and/or, the user equipment determines the CSI report type reserved in the second type set based on the priority rule, where the second number of CSI processing units occupied by the CSI report of the second type set is greater than the second value, and the second number of CSI processing units includes the second number of processing units and/or the fourth number of processing units.

That is, when there are two type sets, and each type set may include a first type of CSI report and/or a second type of CSI report, for any of the type sets, if the number of CSI processing units occupied by the CSI reports in the type set exceeds the number of CSI processing units corresponding to the type set, then it needs to discard some CSI reports with low priority according to the CSI report priority, and retain the remaining CSI reports with high priority, so that the number of CSI processing units occupied by the retained CSI reports does not exceed the number of CSI processing units corresponding to the type set, so as to complete the allocation of CSI processing units.

It should be understood that when the first type set also includes at least one third type of CSI report, the first number of CSI processing units also includes the number of CSI processing units occupied by at least one third type of CSI report. When the second type set also includes at least one third type of CSI report, the second number of CSI processing units also includes the number of CSI processing units occupied by at least one third type of CSI report.

In some examples, the CSI report priority is determined by at least one of the following influence parameters: y, k, c, s; or, the CSI report priority is determined by at least one of the following influence parameters: y, k, c, s, a; wherein y is a value related to the time domain characteristics and reporting resource type of the CSI report, k is a value related to the content carried by the CSI report, c is the serving cell index, s is the report configuration identifier of the CSI report, and a is a value related to whether the CSI report is based on AI.

That is, the CSI report priority can continue to use the traditional method, which is related to the following influence parameters: y, k, c, s, and has nothing to do with whether the CSI report is based on AI. Also, the parameter a indicating whether the CSI report is based on AI can be used as an influence parameter of the CSI report priority.

It should be understood that, since the first type set and the second type set do not need to compete for the CSI processing unit together in this embodiment, the second type set is an AI-based CSI report, and the traditional method can be directly reused. The CSI report priority is determined by at least one of the following influence parameters: y, k, c, s.

The formulas for determining the CSI report priority under different implementations can be found in the above step 420, which will not be repeated here.

Step 430: The user equipment reports to the network device a CSI report corresponding to the CSI report type reserved based on the CSI report priority rule.

Accordingly, the network device receives the CSI report reported by the user equipment. Moreover, the reported CSI report is a CSI report corresponding to the CSI report type reserved by the user equipment in the first type set based on the CSI report priority rule; or, the reported CSI report is a CSI report corresponding to the CSI report type reserved by the user equipment in the second type set based on the CSI report priority rule.

In summary, in the method for determining the CSI processing unit provided in this embodiment, the user equipment determines the number of CSI processing units occupied by the CSI reports of the two type sets respectively, and the number of CSI processing units occupied by the CSI reports of each type set cannot exceed the numerical threshold corresponding to the type set. The number of CSI processing units occupied by the traditional CSI report and the AI-based CSI report are calculated in different type sets respectively, and a new CSI processing unit is introduced separately for the AI-based CSI report.

In addition, the method for determining the CSI processing unit provided in this embodiment defines a method for determining the number of CSI processing units occupied by the AI-based CSI report, and defines a method for determining the priority of the CSI report when the AI-based CSI report competes for the CSI processing unit.

The above embodiments can be implemented separately or in combination, and the embodiments of the present disclosure are not limited to this.

The steps performed by the user equipment in the above embodiments can be implemented separately as a method for determining the CSI processing unit on the user equipment side; and the steps performed by the network device can be implemented separately as a method for determining the CSI processing unit on the network device side.

FIG. 5 shows a block diagram of a device for determining CSI processing unit provided by an embodiment of the present disclosure. The device can be implemented as a part of the user equipment part or all the user equipment through software, hardware, or a combination of both, and the device includes a processing module 510.

The processing module 510 is configured to determine the number of CSI processing units occupied by the CSI reports of the first type set and/or the second type set.

The number of CSI processing units occupied by the CSI reports in the first type set cannot exceed the first value, and the number of CSI processing units occupied by the CSI reports in the second type set cannot exceed the second value.

In some embodiments, the first type set includes a first type of CSI report and/or a second type of CSI report. The first type of CSI report corresponds to at least one of the first number of processing units and the second number of processing units, and the second type of CSI report corresponds to at least one of the third number of processing units and the fourth number of processing units.

In some embodiments, the first type set includes a first type of CSI report and/or a second type of CSI report. The first type of CSI report of the first type set corresponds to the first number of processing units, and the second type of CSI report of the first type set corresponds to the third number of processing units.

The second type set includes a first type of CSI report and/or a second type of CSI report. The first type of CSI report of the second type set corresponds to the second number of processing units, and the second type of CSI report of the second type set corresponds to the fourth number of processing units.

In some embodiments, the second number of processing units is determined by at least one of the following parameters corresponding to the first type of CSI report:
Input parameter value of an AI model;
Output parameter value of the AI model;
Network type of the AI model;
Number of layers of the AI model;
Number of elements per layer of the AI model;
Size of the convolution kernel of the AI model.

In some embodiments, the fourth number of processing units is determined by at least one of the following parameters corresponding to the second type of CSI report:
Input parameter value of an AI model;
Output parameter value of the AI model;
Network type of the AI model;
Number of layers of the AI model;
Number of elements in each layer of the AI model;
Size of the convolution kernel of the AI model.

In some embodiments, the processing module 510 is configured to determine the CSI report type reserved in the first type set based on the CSI report priority rule, where the first number of CSI processing units occupied by the CSI reports of the first type set is greater than the first value.

The number of CSI processing units occupied by the first type of CSI report is the first number of processing units or the second number of processing units, and the number of CSI processing units occupied by the second type of CSI report is the third number of processing units or the fourth number of processing units. The first number of CSI processing units includes the number of CSI processing units occupied by the first type of CSI report and/or the number of CSI processing units occupied by the second type of CSI report.

In some embodiments, the first type set also includes at least one third type of CSI report, and the first number of CSI processing units also includes the number of CSI processing units occupied by the at least one third type of CSI report.

In some embodiments, the processing module 510 is configured to determine the CSI report type reserved in the first type set based on the CSI report priority rule, where the first number of CSI processing units occupied by the CSI report of the first type set is greater than the first value, and the first number of CSI processing units includes the first number of processing units and/or the third number of processing units;
and/or,
the processing module 510 is configured to determine the CSI report type reserved in the second type set based on the CSI report priority rule, where the second number of CSI processing units occupied by the CSI report of the second type set is greater than the second value, and the second number of CSI processing units includes the second number of processing units and/or the fourth number of processing units.

In some embodiments, the first type set also includes at least one third type of CSI report, and the first number of CSI processing units also includes the number of CSI processing units occupied by the at least one third type of CSI report;
and/or,
the second type set also includes the at least one third type of CSI report, and the second number of CSI processing units also includes the number of CSI processing units occupied by the at least one third type of CSI report.

In some embodiments, the device further includes a sending module.

The sending module is configured to report a CSI report corresponding to the CSI report type reserved based on the CSI report priority rule.

In some embodiments, the CSI report priority is determined by at least one of the following influence parameters: y, k, c, s;
or,
the CSI report priority is determined by at least one of the following influence parameters: y, k, c, s, a;
wherein, y is a value related to the time domain characteristics and reporting resource type of the CSI report, k is a value related to the content carried by the CSI report, c is a serving cell index, s is a report configuration identifier of the CSI report, and a is a value related to whether the CSI report is based on AI.

In some embodiments, the reporting amount corresponding to the first type of CSI report includes at least one of the following: CSI reference signal resource indicator-reference signal received power cri-RSRP; synchronization signal block-index-reference signal received power ssb-Index-RSRP; CSI reference signal resource indicator-signal to noise ratio cri-SINR; and synchronization signal block-index-signal to noise ratio ssb-Index-SINR.

In some embodiments, the reporting amount corresponding to the second type of CSI report includes at least one of the following: CSI reference signal resource indicator-rank indication-precoding matrix indication-channel quality indication cri-RI-PMI-CQI; CSI reference signal resource indicator-rank indication-i1 cri-RI-i1; CSI reference signal resource indicator-rank indication-i1-channel quality indication cri-RI-i1-CQI; CSI reference signal resource indicator-rank indication-channel quality indication cri-RI-CQI; CSI reference signal resource indicator-rank indication-L1—precoding matrix indication-channel quality indication cri-RI-LI-PMI-CQI.

In some embodiments, the second type report also includes sub-band CSI, or the number of reference signal ports corresponding to the second type report is greater than 4, or the codebook type corresponding to the second type report is one of the following: Type I-multipanel; Type II; Type II-port selection; Type II-r16; Type II-portselection-r16; Type II-portselection-r17.

In some embodiments, the report corresponding to the third type of CSI report is aperiodic, and the third type of CSI report corresponds to broadband CSI, and the number of reference signal ports corresponding to the third type of CSI report is not greater than 4, and the third type of CSI report has no CSI reference signal resource indicator CRI reported, and the codebook type corresponding to the third type of CSI report is type I-single panel or the reporting amount is CSI reference signal resource indicator-rank indication-channel quality indication cri-RI-CQI.

In some embodiments, the device further includes a sending module.

The sending module is configured to report the capability information of the processing unit. The capability information of the processing unit carries at least one of the following pieces of information: whether the device supports the AI-based CSI processing unit; and the number of the AI-based CSI processing units that can be supported.

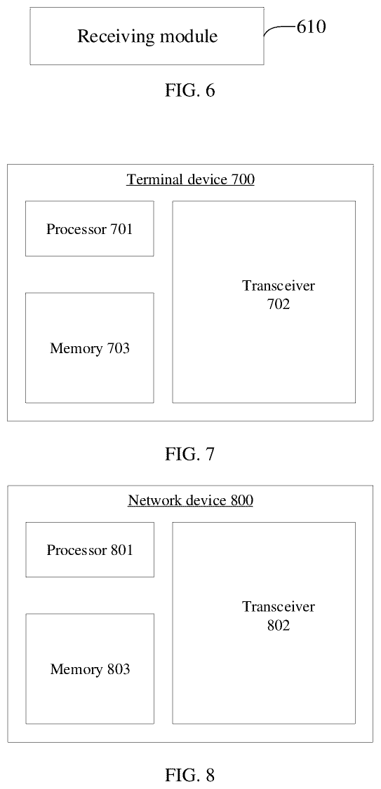

FIG. 6 shows a block diagram of a device for determining a CSI processing unit provided by an embodiment of the present disclosure. The device can be implemented as a part of a network device or all the network device through software, hardware or a combination of both. The device includes a receiving module 610.

The receiving module 610 is configured to receive a CSI report reported by a user equipment.

The CSI report includes a CSI report of the first type set and/or the second type set on the user equipment side. The number of CSI processing units occupied by the CSI report in the first type set cannot exceed the first value, and the number of CSI processing units occupied by the CSI report in the second type set cannot exceed the second value.

In some embodiments, the first type set includes a first type of CSI report and/or a second type of CSI report. The first type of CSI report corresponds to at least one of the first number of processing units and the second number of processing units, and the second type of CSI report corresponds to at least one of the third number of processing units and the fourth number of processing units.

In some embodiments, the first type set includes a first type of CSI report and/or a second type of CSI report. The first type of CSI report of the first type set corresponds to the first number of processing units, and the second type of CSI report of the first type set corresponds to the third number of processing units.

The second type set includes a first type of CSI report and/or a second type of CSI report. The first type of CSI report of the second type set corresponds to the second number of processing units, and the second type of CSI report of the second type set corresponds to the fourth number of processing units.

In some embodiments, the second number of processing units is determined by at least one of the following parameters corresponding to the first type of CSI report:
Input parameter value of an artificial intelligence AI model;
Output parameter value of the AI model;
Network type of the AI model;
Number of layers of the AI model;
Number of elements per layer of the AI model;
Size of convolution kernel of the AI model.

In some embodiments, the fourth number of processing units is determined by at least one of the following parameters corresponding to the second type of CSI report:
Input parameter value of an AI model;
Output parameter value of the AI model;
Network type of the AI model;
Number of layers of the AI model;
Number of elements per layer of the AI model;
Size of convolution kernel of the AI model.

In some embodiments, the CSI report reported by the user equipment is a CSI report corresponding to a CSI report type reserved by the user equipment in the first type set based on a CSI report priority rule, where the first number of CSI processing units occupied by the CSI report of the first type set is greater than the first value.

The number of CSI processing units occupied by the first type of CSI report is the first number of processing units or the second number of processing units, and the number of CSI processing units occupied by the second type of CSI report is the third number of processing units or the fourth number of processing units. The first number of CSI processing units includes the number of CSI processing units occupied by the first type of CSI report and/or the number of CSI processing units occupied by the second type of CSI report.

In some embodiments, the first type set also includes at least one third type of CSI report, and the first number of CSI processing units also includes the number of CSI processing units occupied by the at least one third type of CSI report.

In some embodiments, the CSI report reported by the user equipment is a CSI report corresponding to the CSI report type reserved by the user equipment in the first type set based on the CSI report priority rule, where the first number of CSI processing units occupied by the CSI report of the first type set is greater than the first value, and the first number of CSI processing units includes the first number of processing units and/or the third number of processing units;
and/or,
the CSI report reported by the user equipment is a CSI report corresponding to the CSI report type reserved by the user equipment in the second type set based on the CSI report priority rule, where the second number of CSI processing units occupied by the CSI report of the second type set is greater than the second value, and the second number of CSI processing units includes the second number of processing units and/or the fourth number of processing units.

In some embodiments, the first type set also includes at least one third type of CSI report, and the first number of CSI processing units also includes the number of CSI processing units occupied by the at least one third type of CSI report;
and/or,
the second type set also includes the at least one third type of CSI report, and the second number of CSI processing units also includes the number of CSI processing units occupied by the at least one third type of CSI report.

In some embodiments, the CSI report priority is determined by at least one of the following influence parameters: y, k, c, s;
or,
the CSI report priority is determined by at least one of the following influence parameters: y, k, c, s, a;
where, y is a value related to the time domain characteristics and reporting resource type of the CSI report, k is a value related to the content carried by the CSI report, c is a serving cell index, s is a report configuration identifier of the CSI report, and a is a value related to whether the CSI report is based on AI.

In some embodiments, the reporting amount corresponding to the first type of CSI report includes at least one of the following: CSI reference signal resource indicator-reference signal received power cri-RSRP; synchronization signal block-index-reference signal received power ssb-Index-RSRP; CSI reference signal resource indicator-signal to noise ratio cri-SINR; and synchronization signal block-index-signal to noise ratio ssb-Index-SINR.

In some embodiments, the reporting amount corresponding to the second type of CSI report includes at least one of the following: CSI reference signal resource indicator-rank indication-precoding matrix indication-channel quality indication cri-RI-PMI-CQI; CSI reference signal resource indicator-rank indication-i1 cri-RI-i1; CSI reference signal resource indicator-rank indication-i1-channel quality indication cri-RI-i1-CQI; CSI reference signal resource indicator-rank indication-channel quality indication cri-RI-CQI; and CSI reference signal resource indicator-rank indication-L1—precoding matrix indication-channel quality indication cri-RI-LI-PMI-CQI.

In some embodiments, the second type report also includes sub-band CSI, or the number of reference signal ports corresponding to the second type report is greater than 4, or the codebook type corresponding to the second type report is one of the following: Type I-multipanel; Type II; Type II-port selection; Type II-r43; Type II-portselection-r43; Type II-portselection-r44.

In some embodiments, the report corresponding to the third type of CSI report is aperiodic. The third type of CSI report corresponds to broadband CSI. The number of ports is not greater than 4. The third type of CSI report has no CSI reference signal resource indicator CRI reported. The codebook type corresponding to the third type of CSI report is type I-single panel or the reporting amount is CSI reference signal resource indicator-rank indication-channel quality indication cri-RI-CQI.

In some embodiments, the receiving module 610 is configured to receive the capability information of the processing unit reported by the user equipment; wherein the capability information of the processing unit carries at least one of the following pieces of information: whether the user equipment supports the AI-based CSI processing unit; and the number of the AI-based CSI processing unit.

FIG. 7 shows a schematic diagram of the structure of a user equipment provided by an embodiment of the present application. The user equipment 700 includes a processor 701, a transceiver 702 and a memory 703.

The processor 701 includes one or more processing cores. The processor 701 executes various functional applications by running software programs and modules.

The transceiver 702 can be configured to receive and send information, and the transceiver 702 can be a communication chip.

The memory 703 can be configured to store a computer program, and the processor 701 is configured to execute the computer program to implement the various steps performed by the user equipment in the above method embodiment.

In addition, the memory 703 can be implemented by any type of volatile or non-volatile storage device or a combination thereof, and the volatile or non-volatile storage device includes but is not limited to: random access memory (RAM) and read-only memory (ROM), erasable programmable read-only memory (EPROM), electrically erasable programmable read-only memory (EEPROM), flash memory or other solid-state storage technology, compact disc read-only memory (CD-ROM), high-density digital video disc (DVD) or other optical storage, tape cassette, tape, disk storage or other magnetic storage device.

FIG. 8 shows a schematic diagram of a structure of a network device provided by an embodiment of the present application. The network device 800 includes a processor 801, a transceiver 802, and a memory 803.

The processor 801 includes one or more processing cores, and the processor 801 executes various functional applications by running software programs and modules.

The transceiver 802 can be configured to receive and send information, and the transceiver 802 can be a communication chip.

The memory 803 can be configured to store a computer program, and the processor 801 is configured to execute the computer program to implement the various steps performed by the network device in the above method embodiment.

In addition, the memory 803 can be implemented by any type of volatile or non-volatile storage device or a combination thereof, and the volatile or non-volatile storage device includes but is not limited to: random access memory (RAM) and read-only memory (ROM), erasable programmable read-only memory (EPROM), electrically erasable programmable read-only memory (EEPROM), flash memory or other solid-state storage technology, compact disc read-only memory (CD-ROM), high-density digital video disc (DVD) or other optical storage, tape cassette, tape, disk storage or other magnetic storage device.

An embodiment of the present disclosure also provides a computer-readable storage medium, in which at least one instruction, at least one program, code set or instruction set is stored. The at least one instruction, the at least one program, the code set or instruction set is loaded and executed by the processor to implement the method for determining the CSI processing unit provided by the above-mentioned various method embodiments.

An embodiment of the present disclosure also provides a chip. The chip includes a programmable logic circuit and/or a program instruction. When the chip is running, it is configured to implement the method for determining the CSI processing unit described in the above aspects.

An embodiment of the present disclosure also provides a computer program product. The computer program product includes a computer instruction. The computer instruction is stored in a computer-readable storage medium. The processor of the computer device reads the computer instruction from the computer-readable storage medium, and the processor executes the computer instruction, so that the computer device executes the method for determining the CSI processing unit provided by the above-mentioned various method embodiments.

It should be understood that the terms “system” and “network” are often used interchangeably herein. The term “and/or” herein is only a description of the association relationship of the associated objects, indicating that there can be three relationships. For example, A and/or B can represent: A alone, both A and B, and B alone. In addition, the character “/” herein generally indicates that the associated objects before and after it are in an “or” relationship. It should also be understood that the “indication” mentioned in the embodiments of the present disclosure can be a direct indication, an indirect indication, or an indication of an association relationship. For example, A indicates B, which may mean that A directly indicates B. For example, B can be obtained through A. It may also mean that A indirectly indicates B. For example, A indicates C, and B can be obtained through C. It may also mean that A and B have an association relationship. It should also be understood that the “correspondence” mentioned in the embodiments of the present disclosure may mean that there is a direct or indirect correspondence relationship between the two, or it may mean that there is an association relationship between the two, or it may mean that there is a relationship of indicating and being indicated, configuring and being configured, etc. It should also be understood that the “predefined”, “protocol agreement”, “predetermined” or “predefined rule” mentioned in the embodiments of the present disclosure may be implemented by pre-saving corresponding codes, tables or other information indicating relevant information in a device (for example, including a network device and a user equipment), and the present disclosure does not limit the specific implementation. For example, predefinition may refer to a definition in a protocol. It should also be understood that in the embodiments of the present disclosure, the “protocol” may refer to a standard protocol in the field of communications. For example, it may include an LTE protocol, an NR protocol, and related protocols used in future communication systems, and the present disclosure does not limit this.

After considering the specification and practicing the disclosure herein, those skilled in the art will easily think of other embodiments of the present disclosure. The present disclosure is intended to cover any variation, use or adaptation of the present disclosure, which follows the general principles of the present disclosure and includes common knowledge or customary technical means in the technical field that are not disclosed in the present disclosure. The description and embodiments are to be regarded as exemplary only, and the true scope and spirit of the present disclosure are indicated by the following claims.

It should be understood that the present disclosure is not limited to the precise structure described above and shown in the accompanying drawings, and various modifications and changes can be made without departing from its scope. The scope of the present disclosure is limited only by the appended claims.

1. A method for determining a channel state information (CSI) processing unit, performed by a user equipment, comprising:
determining a number of CSI processing units occupied by a CSI report of at least one of a first type set or a second type set;
wherein the number of CSI processing units occupied by the CSI report in the first type set cannot exceed a first value, and the number of CSI processing units occupied by the CSI report in the second type set cannot exceed a second value.

2. The method according to claim 1, wherein
the first type set comprises at least one of a first type of CSI report or a second type of CSI report; wherein the first type of CSI report corresponds to at least one of a first number of processing units or a second number of processing units, and the second type of CSI report corresponds to at least one of a third number of processing units or a fourth number of processing units.

3. The method according to claim 1, wherein
the first type set comprises at least one of a first type of CSI report or a second type of CSI report, wherein the first type of CSI report of the first type set corresponds to a first number of processing units, and the second type of CSI report of the first type set corresponds to a third number of processing units; and
the second type set comprises at least one of a first type of CSI report or a second type of CSI report, wherein the first type of CSI report of the second type set corresponds to a second number of processing units, and the second type of CSI report of the second type set corresponds to a fourth number of processing units.

4. (canceled)

5. (canceled)

6. The method according to claim 2, further comprising:
determining a CSI report type reserved in the first type set based on a CSI report priority rule, wherein a first number of CSI processing units occupied by the CSI report of the first type set is greater than the first value;
wherein the number of CSI processing units occupied by the first type of CSI report is the first number of processing units or the second number of processing units, the number of CSI processing units occupied by the second type of CSI report is the third number of processing units or the fourth number of processing units, and the first number of CSI processing units comprises at least one of the number of CSI processing units occupied by the first type of CSI report or the number of CSI processing units occupied by the second type of CSI report.

7. The method according to claim 6, wherein
the first type set further comprises at least one third type of CSI report, and the first number of CSI processing units further comprises a number of CSI processing units occupied by the at least one third type of CSI report.

8. The method according to claim 3, further comprising at least one of:
determining a CSI report type reserved in the first type set based on a CSI report priority rule, wherein a first number of CSI processing units occupied by the CSI report of the first type set is greater than the first value, and the first number of CSI processing units comprises at least one of the first number of processing units or the third number of processing units; or
determining a CSI report type reserved in the second type set based on the CSI report priority rule, wherein a second number of CSI processing units occupied by the CSI report of the second type set is greater than the second value, and the second number of CSI processing units comprises at least one of the second number of processing units or the fourth number of processing units.

9. The method according to claim 8, further comprising at least one of:
the first type set further comprising at least one third type of CSI report, and the first number of CSI processing units further comprising a number of CSI processing units occupied by the at least one third type of CSI report; or
the second type set further comprising the at least one third type of CSI report, and the second number of CSI processing units further comprising a number of CSI processing units occupied by the at least one third type of CSI report.

10. The method according to claim 6 , further comprising:
reporting a CSI report corresponding to the CSI report type reserved based on the CSI report priority rule.

11.-15. (canceled)

16. The method according to claim 1, further comprising:
reporting capability information of the CSI processing unit;
wherein the capability information of the CSI processing unit carries at least one of:
whether the user equipment supports an AI-based CSI processing unit; or
a number of the AI-based CSI processing units that can be supported.

17. A method for determining a channel state information (CSI) processing unit, performed by a network device, comprising:
receiving a CSI report reported by a user equipment;
wherein the CSI report comprises a CSI report of at least one of a first type set or a second type set on the user equipment side; a number of CSI processing units occupied by the CSI report in the first type set cannot exceed a first value, and a number of CSI processing units occupied by the CSI report in the second type set cannot exceed a second value.

18. The method according to claim 17, wherein
the first type set comprises at least one of a first type of CSI report or a second type of CSI report; wherein the first type of CSI report corresponds to at least one of a first number of processing units or a second number of processing units, and the second type of CSI report corresponds to at least one of a third number of processing units or a fourth number of processing units.

19. The method according to claim 17, wherein
the first type set comprises at least one of a first type of CSI report or a second type of CSI report, wherein the first type of CSI report of the first type set corresponds to a first number of processing units, and the second type of CSI report of the first type set corresponds to a third number of processing units; and
the second type set comprises at least one of a first type of CSI report or a second type of CSI report, wherein the first type of CSI report of the second type set corresponds to a second number of processing units, and the second type of CSI report of the second type set corresponds to a fourth number of processing units.

20. (canceled)

21. (canceled)

22. The method according to claim 18, wherein the CSI report reported by the user equipment is a CSI report corresponding to a CSI report type reserved by the user equipment in the first type set based on a CSI report priority rule, wherein a first number of CSI processing units occupied by the CSI report of the first type set is greater than the first value;
wherein the number of CSI processing units occupied by the first type of CSI report is the first number of processing units or the second number of processing units, the number of CSI processing units occupied by the second type of CSI report is the third number of processing units or the fourth number of processing units, and the first number of CSI processing units comprises at least one of the number of CSI processing units occupied by the first type of CSI report or the number of CSI processing units occupied by the second type of CSI report.

23. The method according to claim 22, wherein
the first type set further comprises at least one third type of CSI report, and the first number of CSI processing units further comprises a number of CSI processing units occupied by the at least one third type of CSI report.

24. The method according to claim 19, wherein the CSI report reported by the user equipment is at least one of:
a CSI report corresponding to a CSI report type reserved by the user equipment in the first type set based on a CSI report priority rule, wherein a first number of CSI processing units occupied by the CSI report of the first type set is greater than the first value, and the first number of CSI processing units comprises at least one of the first number of processing units or the third number of processing units; or
a CSI report corresponding to a CSI report type reserved by the user equipment in the second type set based on the CSI report priority rule, wherein a second number of CSI processing units occupied by the CSI report of the second type set is greater than the second value, and the second number of CSI processing units comprises at least one of the second number of processing units or the fourth number of processing units.

25. The method according to claim 24, further comprising at least one of:
the first type set further comprising at least one third type of CSI report, and the first number of CSI processing units further comprising a number of CSI processing units occupied by the at least one third type of CSI report; or
the second type set further comprising the at least one third type of CSI report, and the second number of CSI processing units further comprising a number of CSI processing units occupied by the at least one third type of CSI report.

26.-30. (canceled)

31. The method according to claim 17, further comprising:
receiving capability information of the CSI processing unit reported by the user equipment;
wherein the capability information of the CSI processing unit carries at least one of:
whether the user equipment supports an AI-based CSI processing unit; or
a number of the AI-based CSI processing units that can be supported.

32. (canceled)

33. (canceled)

34. A user equipment, comprising:
a processor; and
a transceiver connected to the processor;
wherein the processor is configured to:
determine a number of channel state information (CSI) processing units occupied by a CSI report of at least one of a first type set or a second type set;
wherein the number of CSI processing units occupied by the CSI report in the first type set cannot exceed a first value, and the number of CSI processing units occupied by the CSI report in the second type set cannot exceed a second value.

35. A network device, comprising:
a processor; and
a transceiver connected to the processor;
wherein the processor is configured to perform the method according to claim 17.

36. (canceled)

37. (canceled)

38. The method according to claim 8, further comprising:
reporting a CSI report corresponding to the CSI report type reserved based on the CSI report priority rule.
